(19) United States
(12) Patent Application Publication
(10) Pub. No.: US 2020/0198883 A1
(43) Pub. Date: Jun. 25, 2020

(54) KIT FOR A CONFECTIONERY PRODUCT AND A METHOD RELATED THEREOF

(71) Applicant: Ricardo Haces Menéndez, Puebla (MX)

(72) Inventor: Ricardo Haces Menéndez, Puebla (MX)

(21) Appl. No.: 16/701,164

(22) Filed: Dec. 3, 2019

(30) Foreign Application Priority Data
Dec. 19, 2018 (MX) MX/U/2018/000810

(51) Int. Cl. B65D 85/60

(52) U.S. Cl. CPC B65D 85/60; A23G 3/54

(57) ABSTRACT

A kit for a confectionery product and a method related thereof. The kit comprises a container with one or more ground edibles, and one or more lollipops disposed within the container.

### CROSS-REFERENCE TO RELATED APPLICATIONS

This application claims priority to and the benefit of the utility model patent application titled “Lollipop In A Package With Ground Cookie Included”, application number MX/E/2018/096095, filed in the Mexican Institute of Industrial Property on Dec. 19, 2018. The specification of the above referenced utility model patent application is incorporated herein by reference in its entirety.

### BACKGROUND

The apparatus disclosed herein generally relates to a kit for a confectionery product comprising a hard candy, for example a lollipop, and a ground cookie that are consumed together or separately, and a method related to thereof.

Food businesses involve different types of manufacturing processes, and production of different types of products. An example, is a confectionery and pastry business in which the products are generally classified into categories comprising cookies, cakes, chocolates, candies, powdered sweets, liquid sweets, chewing gums, marshmallows, etc. and these, in-turn, are subcategorized into sweet, salty, filled cookies, dark chocolates filled with milk or cream, hard, soft, filled candies, etc.

Dipping a food item directly into another food item is a common practice in food manufacturing, food service, and amongst consumers in general. For increased flexibility of use and consumption of food products, a need exists to package a solid, semisolid or substantially solid food with a second food in a container, to form a combined food product. Such combination foods comprise, for example, a combination of a beverage and ice cream, a combination of a dairy product and breakfast cereal, a combination of heated water and a solid coffee beverage mix, a combination of heated water and an oatmeal or other such breakfast preparation, and other materials where a solid food and a second food are mixed in a container to prepare a combination food. Such combination foods can also comprise combination of two substantially solid foods for example, yogurt and cereal, ice cream and a bakery product, etc.

Over the years, various types of lollipops and hard candy pops have been produced in multiple shapes, sizes, and flavors. The lollipops and hard candy pops comprise a hard candy mounted on a stick to allow the candy to be licked by repeated placement of the candy in the user's mouth, and removal of the candy from the user's mouth without the candy contacting the user's hand. It would be desirable to make alternative edible formats for such lollipops and hard candy pops by mixing two or more forms of confectionery products that will allow a high degree of convenience for snacking of the products. Cookies or biscuits are confectionery products, typically having a sweet taste and a flat, small, and round shape, for example an Oreo® cookie manufactured by Nabisco of New Jersey, United States of America. The cookies or biscuits are available in the market in the form of sandwiches, covered, filled, decorated, alone, or in physical combination with other confectionery products such as ice cream, caramels, jams, marshmallows, dragees, chocolates, frosting sugared, fondant, with fruits, chips, etc. However, a few consumers find that intimately crushing and mixing a candy product with another product is distasteful, and prefer tasting the candy product and the other product separately. In a confectionery product where two products are intimately ground and mixed, the consumers are deprived of being able to taste the products separately, which a consumer may wish to do.

Hence, there is a long felt yet unresolved need for a kit for a confectionery product comprising a lollipop, and a ground cookie that eliminates the aforementioned drawbacks.

### SUMMARY OF THE INVENTION

This summary is provided to introduce a selection of concepts in a simplified form that are further disclosed in the detailed description of the invention. This summary is not intended to determine the scope of the claimed subject matter.

The kit for a confectionery product disclosed herein comprises a container, a combination of one or more candies mounted on a stick, and one or more ground edible fillings, hereafter a ground edible, and a method related thereof. The container comprises an enclosed interior volume. The one or more candies mounted on a stick, and the one or more ground edibles are disposed within the interior volume of the container.

In an embodiment, the ground edible is a ground and powdered food. For example, the ground edible comprises a ground cookie powder.

In an embodiment, the ground edible comprises a food selected from a group comprising a confectionary, biscuit, cookie, and powdered chocolate.

In an embodiment, the candy on the stick is a lollipop, for example a lollipop comprising a filler material with a coating of hardened candy, a filler material coated with a hardened chocolate, etc. In an embodiment, the ground edible comprises one or more of a jelly, a chocolate, etc. In an embodiment, the candy is a lollipop with or without a filler material.

In an embodiment, the lollipop and the ground edible disposed in the kit are consumed separately, i.e., the lollipop is consumed at one time, and the ground edible is consumed at another time. In another embodiment, the lollipop and the ground edible disposed in the kit are consumed together, i.e., the lollipop is dipped in the ground edible, and thereafter the lollipop is consumed with the ground edible adhering to surface of the lollipop.

### BRIEF DESCRIPTION OF DRAWINGS

This summary is provided to introduce a selection of concepts in a simplified form that are further disclosed in the detailed description of the invention. This summary is not intended to determine the scope of the claimed subject matter.

FIG. 1 exemplarily illustrates a perspective view of a kit for a confectionery product.

FIG. 2 exemplarily illustrates a front view of the kit for the confectionery product.

FIG. 3 exemplarily illustrates a front view of the kit for the confectionery product comprising a flexible container filled with about 75% of its volume with a ground edible and a candy mounted on a stick.

FIG. 4 exemplarily illustrates an isometric view of the flexible container in an open position showing the ground edible and the candy mounted on a stick in the flexible container.

FIG. 5 exemplarily illustrates a front view of an alternative embodiment of the kit for the confectionery product.

FIG. 6 illustrates a flowchart depicting a method of packaging a confectionery product.

### DETAILED DESCRIPTION OF THE INVENTION

The apparatus disclosed herein provides a kit for a confectionery product, for example, a kit for storing one or more candies mounted on a stick, and one or more ground edibles.

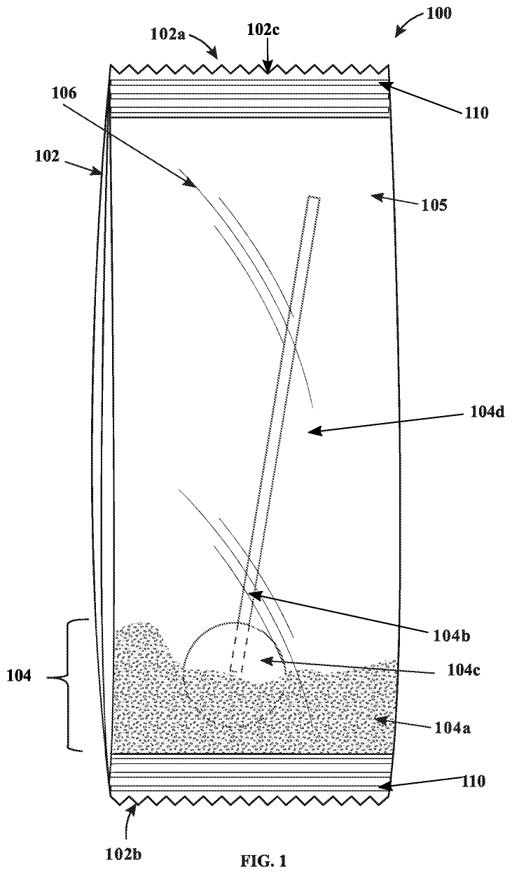

FIG. 1 exemplarily illustrates a perspective view of the kit 100 for the confectionery product disclosed herein. As used herein, a lollipop 104d comprises a candy 104c mounted on a stick 104b. The kit 100 for the confectionery product comprises a container 102, a ground edible 104a, and a lollipop 104d. In an embodiment, the kit 100 for the confectionery product comprises a container 102, one or more ground edibles 104a, and one or more lollipops 104d. In an embodiment, the candy 104c comprises a hard sugar candy, a hard sugar flavored candy, for example, flavored with an orange flavor, a lime flavor, a cherry flavor, a peach flavor, etc., a chocolate candy, a gelatin candy, etc. In an embodiment, the ground edible 104a comprises a ground cookie, a ground cereal, a ground chocolate, a ground nut, a ground confectionary, a ground food, etc., ground to a predetermined mesh size. In an embodiment, the ground edible 104a is adapted to coat and removably adhere to the candy 104c on the stick 104b. In an embodiment, the ground edible 104a is ground and thereafter disposed in the container 102. The ground edible 104a and the lollipop 104d are disposed within the container 102 and the container 102 is thereafter pressure sealed at an upper end 102a of the flexible container 102. In an embodiment, more than one ground edible 104a and more than one lollipop 104d are disposed and packaged in the container 102.

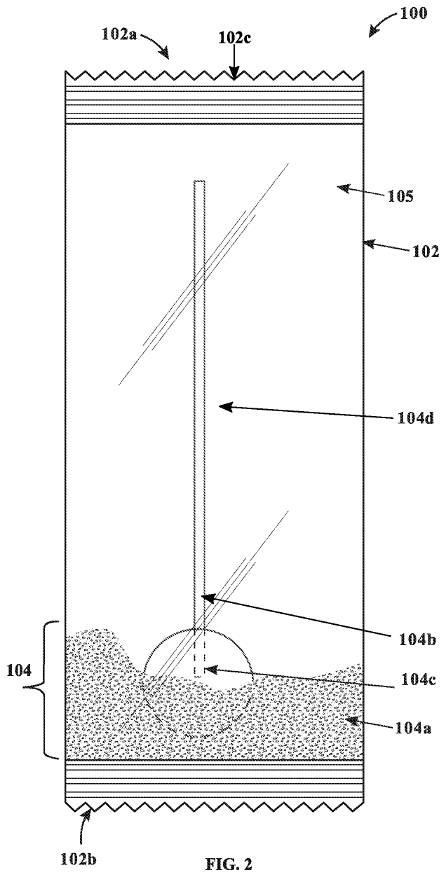

To use the confectionery product, the user opens the closed container 102 at the sealed end 102a of the container, holds the lollipop 104d with the stick 104b, licks the candy 104c, dips the candy 104c in the ground cookie 104a, and licks the ground edible 104a off the surface of the candy 104c. This process is repeated till the ground cookie 104a and/or the lollipop 104d is consumed. In an embodiment, the ground edible 104a is contained within about the lower 25% portion of the container 102 as shown in FIGS. 1 and 2.

In an embodiment, the ground edible 104a adhering to the lollipop 104d after the lollipop is licked and dipped in the ground edible 104a, is licked off the lollipop 104d and consumed first, and the candy 104c remaining on the lollipop 104d is licked or otherwise consumed after the ground edible 104a is consumed. In another embodiment, the candy 104c is licked by the user and consumed or substantially consumed, and the ground edible 104a is consumed by the user alone or with the remaining candy 104c.

In an embodiment, as illustrated in FIGS. 1-3, the kit 100 for the confectionery product comprises a flexible container 102, for example, an aluminum pouch, a plastic pouch, a plastic-aluminum combination pouch, a plastic lined paper pouch, etc., within which the lollipop 104d and a ground edible 104a is disposed. The confectionary product is packaged as follows: the lollipop 104d and the ground edible 104a is placed in the flexible container 102, after which the flexible container 102 is pressure sealed at an upper end 102a of the flexible container 102. To open the sealed flexible container 102, the user manually tears the flexible container 102 across the upper sealed end 102a of the flexible container 102, or cuts the upper end 102a of the flexible container 102 with a knife or a pair of scissors. In an embodiment, the flexible container 102 is opened by tearing the flexible container 102 across the top at a notch 102c in a side seam (not shown) in the flexible container. After the flexible container 102 is opened, the user consumes the ground edible 104a and lollipop 104d as disclosed in paragraphs [0022] and [0023] above.

In an embodiment, the container 102 comprises a seal 110 at an upper end 102a and a seal 110 at the lower end 102b. The container 102 further comprises an outer surface 106.

FIG. 2 exemplarily illustrates a front view of the kit for the confectionery product. FIG. 2 illustrates a single lollipop disposed in the container 102. In an embodiment, more than one ground edible 104a and more than one lollipop 104d is disposed and packaged within the container 102. In an embodiment, the candy 04c is manufactured in one or more shapes, sizes, flavors, colors, and acidified or non-acidified. In another embodiment, the stick portion 104d of the lollipop 104b is manufactured in one or more shapes, sizes, and colors. In an embodiment, the container 102 is clear or translucent to allow a user to view the ground edible 104a and the lollipop 104d disposed in the kit 100. In another embodiment, the container 102 is opaque.

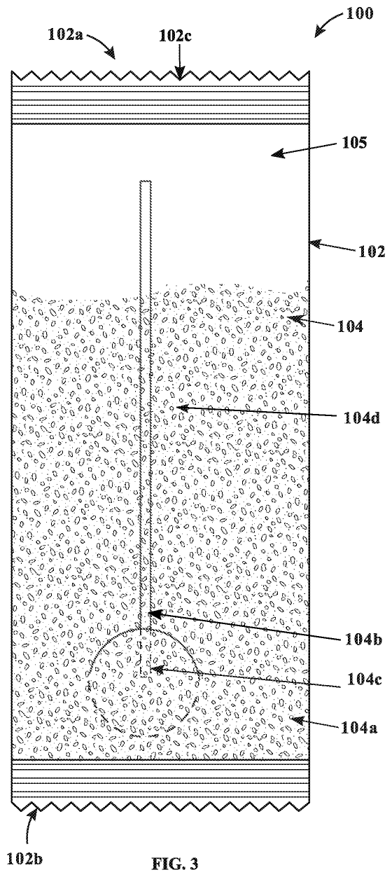

FIG. 3 exemplarily illustrates a front view of another embodiment of the kit 100 for the confectionery product. In the embodiment illustrated in FIG. 3, the flexible container 102 is filled to about 75% of its volume with a ground edible 104a and a candy mounted on a stick 104d.

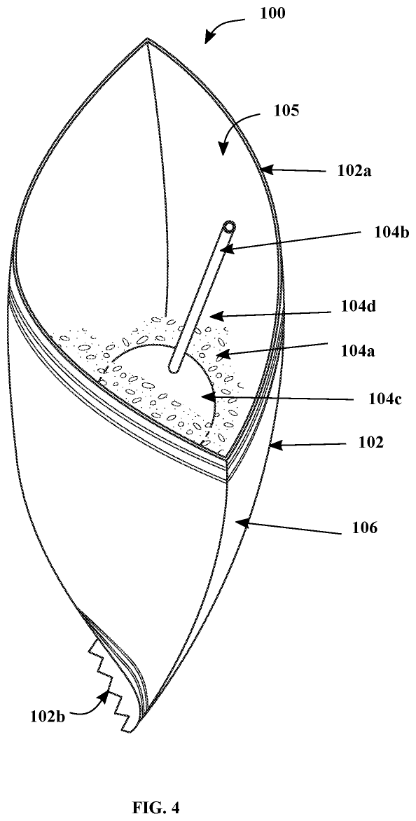

FIG. 4 exemplarily illustrates an isometric view of the flexible container 102 in an open position showing the ground edible 104a and the candy mounted on a stick 104d in the flexible container 102.

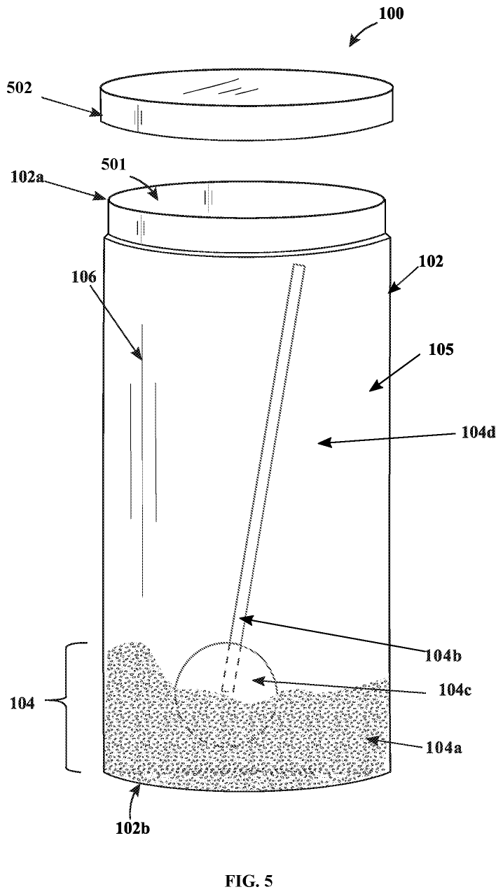

FIG. 5 exemplarily illustrates a front view of an embodiment of the kit 100 for the confectionery product. In this embodiment, the container 102 comprises an opening 501 defined on the container 102, an interior volume 105 extending from the opening 501 to the bottom 102b of the container 102, a ground edible 104a and a lollipop 104d.

In an embodiment, the opening 501 is defined at an upper end 102a of the container 102. The interior volume 105 of the container 102 is defined by the portion of the container 102 that extends from the opening 501 at the upper end 102a of the container 102 towards a lower end 102b of the container 102. The interior volume 105 of the container 102 is bound by an interior surface of the portion of the container 102 that extends from the opening 501 at the upper end 102a of the container 102 and the lower end 102b of the container 102. The ground edible 104a is disposed within the interior volume 105 of the container 102. In an embodiment, the container 102 has a uniform wall thickness. A lid 502 secures an upper end 102a of the container 102. In an embodiment, the ground edible 104a is filled to about 25% of the volume of the container 102. In another embodiment, the edible filling 104a is filled to about 75% of the volume of the container 102.

In an embodiment, the container 102 is made of a non-flexible packaging material. In an embodiment, the packaging material for fabricating the container 102 is made of materials comprising aluminum foil and plastic. For example, in an embodiment the container 102 is made of paper, a combination of a plastic and metal foil, etc.

In an embodiment, the ground edible 104a comprises a ground cookie, a ground cereal, a ground chocolate, a ground nut, a ground confectionary, a ground food, etc. In an embodiment, the ground edible 104a is adapted to coat and removably adhere to the candy 104c on the stick 104b.

The lollipop 104b is manufactured using well known conventional processes for the manufacture of a lollipop. Two processes are currently used for the industrial manufacture of lollipops, namely die-forming and/or depositing in a mold. The lollipop manufacturing process involves mixing sugar, corn syrup, and water in a dissolving tank for a predetermined time at a predetermined temperature period until a homogeneous syrup is obtained. The syrup is transferred to a vessel equipped with a steam coil to concentrate the syrup. The concentrated syrup is further concentrated in a cooker under a vacuum system at a predetermined temperature and predetermined vacuum pressure to reduce moisture in the syrup to obtain a concentrated sugar based mass. The concentrated sugar based mass is mixed with acidifiers, coloring agents, and flavoring agents. The flavored and colored sugar based mass is cut in die cutting equipment and a plastic/paper stick is embedded in the lollipop mass to produce the lollipop 104d. The lollipop 104d is transported through a cooling tunnel and then to a wrapping machine where the lollipop 104d is packaged.

To make a ground edible 104a, an edible is broken into small granular pieces, and then ground into smaller granular pieces to create the ground edible 104a. In an embodiment, the ground edible 104a is further reduced in size to obtain a powdered edible. The ground edible 104a is also available commercially as a raw material, packaged in kraft bags with an inner polyethylene bag and with an ambient humidity of about 1-5% relative humidity within the polyethylene bag to allow the ground edible 104a to removably adhere to the lollipop 104b.

Measurement of size of granular pieces in the ground edible 104a is performed using a mesh size analysis of the ground edible. “Mesh” is the size of the mesh opening in the sieve. Table 1 shown below illustrates the sieve analysis of ground edible 104a batch.

The sieve size analysis is a range of the percentage weight of the ground edible 104a batch that passes through a sieve of a particular mesh size. In the below table, the column “Mesh” represents the mesh size of the sieve. The column “% of ground edible 104a that passes through mesh” represents the percentage weight range of a particular ground edible 104a batch that passes through the corresponding mesh size.

TABLE 1

| Mesh | % of ground edible 104a that passes through mesh |
|---|---|
| 10 | About 55 to about 65 |
| 14 | About 25 to about 35 |
| 25 | About 10 to about 4 |

Table 1 shows for a particular ground edible 104a batch, about 55% to about 65% by weight of a ground edible 104a batch must pass through a sieve having a mesh size of 10, about 25% to about 35% by weight of the ground edible 104a batch must pass through a sieve having a mesh size of 14, and about 10% to about 4% by weight of the ground edible 104a batch must pass through a sieve having a mesh size of 25.

In an embodiment, the lollipop 104d is over-wrapped with a paper wrap prior to disposing the lollipop 104d with the ground edible 104a in the container 102. In another embodiment, the lollipop 104d is packed with the edible filing 104a in the container 102 without an over-wrap around the lollipop 104d. In an embodiment, the lollipop 104d and the edible filling 104a is disposed in the container using a substantially manual process for transferring the lollipop and the ground edible 104a into the container 102. In another embodiment, the lollipop 104d and the edible filing 104a are placed in a packaging machine comprising two hoppers. The lollipop 104b is placed in one of the hoppers and the edible filing 104a is placed in another one of the hoppers. The packaging machine transfers and packages the lollipop 104b and the edible filing 104a into a container 102 to produce a single kit for a confectionary product 100. The kit 100 is marketed to the consumer.

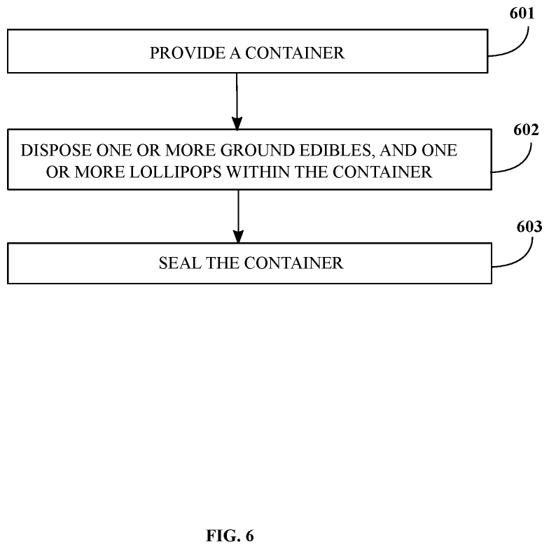

FIG. 6 is a flowchart depicting a method of packaging a confectionery product. The method comprises providing 601 a container 102. The method further comprises disposing 602 one or more ground edibles 104a and one or more lollipops 104 within an interior volume 105 of the container 102. The method further comprises sealing 603 the container 102 after the container is filled with one or more ground edibles 401a and one or more lollipops 104. In an embodiment, the one or more ground edibles 104a and the one or more lollipops 104 is filled into the container through an upper end 102a of the container 102 and the upper end 102a of the container 102 is sealed. Thus, the kit for a confectionary product 100 is formed by the aforementioned method.

The foregoing examples have been provided merely for explanation and are in no way to be construed as limiting of the method and the kit 100 for the confectionery product disclosed herein. While the method and the kit 100 have been described with reference to various embodiments, it is understood that the words, which have been used herein, are words of description and illustration, rather than words of limitation. Furthermore, although the method and the kit 100 have been described herein with reference to particular means, materials, and embodiments, the method and the kit 100 are not intended to be limited to the particulars disclosed herein; rather, the method 200 and the kit 100 extend to all functionally equivalent structures, methods and uses, such as are within the scope of the appended claims. While multiple embodiments are disclosed, it will be understood by those skilled in the art, having the benefit of the teachings of this specification, that the method and the kit 100 disclosed herein are capable of modifications and other embodiments may be effected and changes may be made thereto, without departing from the scope and spirit of the method and the kit 100 disclosed herein.

I claim:

1. A kit for a confectionery product, said kit comprising:
a container; and
one or more ground edibles, and one or more lollipops disposed within an interior volume of the container.

2. The kit of claim 1, wherein the ground edibles comprise one or more of a ground cookie, a ground cereal, a ground chocolate, a ground nut, a ground confectionary, and a ground food.

3. The kit of claim 1, wherein the container comprises an opening, and wherein the opening is pressure sealed after the ground filling and the lollipop is disposed in the container.

4. The kit of claim 1, wherein the container comprises a plastic pouch, an aluminium foil pouch, a paper pouch, and a plastic lined paper pouch.

5. The kit of claim 1, wherein the interior volume of the container extends from an opening at an upper end of the container to a lower end of the container.

6. The kit of claim 9, wherein the kit further comprises a lid for securing the opening at the upper end of the container.

7. A method of packaging a confectionery product, comprising:
providing a container;
disposing one or more ground edibles, and one or more lollipops within the container; and
sealing the container.

8. The method of claim 11, wherein the container is a flexible container and the flexible container is pressure sealed at the upper end of the flexible container.

9. The method of claim 11, wherein the container is sealed by securing a lid around the upper end of the container.
